(19) United States
(12) Patent Application Publication
(10) Pub. No.: US 2002/0020267 A1
(43) Pub. Date: Feb. 21, 2002

(54) Photographic web cutter device

(76) Inventor: Vanni Leopoldo Beggiao, Padova (IT)

Correspondence Address: WEINGARTEN, SCHURGIN, GAGNEBIN, & HAYES, LLP, TEN POST OFFICE SQUARE, BOSTON, MA, 02109, US

(21) Appl. No.: 09/776,259

(22) Filed: Feb. 2, 2001

(30) Foreign Application Priority Data
Feb. 3, 2000 (EP) 00 102 412.4
Jul. 25, 2000 (EP) 00 115 034.1

(51) Int. Cl. B26D 5/00

(52) U.S. Cl. 83/76.8; 83/155; 83/102; 83/650

(57) ABSTRACT

The present invention relates to a photographic web cutter device for cutting a web of photographic paper prints, a so called batch, related to a plurality of customer orders, including magazines for the web or batch, a cutter portion and a control portion, and according to the invention said control portion controls the cutting operation by means of control data so that cut parts of the photographic web can be assigned to a related customer order.

### CROSS REFERENCE TO RELATED APPLICATIONS

This application claims the priority of the European patent application no. 00 102 412.4 filed on Feb. 3, 2000 and entitled “Photographic Web Cutter Device”. The disclosure of this reference is incorporated in this application by reference.

### FIELD OF THE INVENTION

The present invention relates to the field of photo finishing laboratories and in particular to the field of large dimension photo finishing labs. Preferably, the present invention relates to photographic web cutter devices for cutting webs of photographic negatives and/or a web of photographic paper prints related to a plurality of customer orders.

In large dimension photo finishing labs, it is common that a huge number of customer orders are received in the shape of exposed, undeveloped films. These films are spliced together to provide a reel or roll with undeveloped films, called film batch. These undeveloped films are then developed and processed in accordance with the special wishes or instructions of the customers.

The films representing the orders of the customers are received in the lab wrapped in envelopes. The envelopes can be identified by codes, in particular two bar codes, one of them being assigned to the photo shop or dealer, and the other being assigned to a specific customer, i.e. his order. Thus it is always possible to assign an order to the corresponding customer.

According to the customers wishes, the photographs of one film can be exposed on photosensitive print paper of different types or qualities. In addition, the customer can order different formats, for instance this could mean in an extreme case that one customer could order that a particular number of photographs of his film be exposed on matt paper and another number of photographs be exposed on glossy paper, and furthermore he wishes that another number of photographs of the same film be exposed on royal print paper. Usually the different paper qualities are termed “matt”, “glossy” and “royal”. Other paper qualities may arise or be chosen by the customer. However, it is more usual that a customer orders one film to be exposed on one special kind of paper quality, while another customer chooses another type of paper quality.

Accordingly the different orders of the customers can be exposed on different print paper types. Later it will be necessary to assign the finished prints on the paper of different types to the particular negative films of the various customers.

In principle, the same is true if the order of a customer or several orders of many customers is/are received via an electronic line, for instance a telephone line, the internet or the like. Also, in this case, the image data have to be printed on different print papers of different quality and the prints have to be assigned to the orders of particular customers who transmitted their orders via the electronic line or telephone line.

However, automatically assigning the prints to the orders or to the negative films, based on which the orders of the customers have been completed, is problematic.

### SUMMARY OF THE INVENTION

It is an object of the present invention to provide a solution which is at least partially able to deal with the above problems. According to the invention, additionally the following are to be settled at least partially:

to assign the prints of one customer order after the completion of the customer order to the exposed film of the customer order;

to assign the prints of several customer orders after the completion of the customer order to the respect exposed films of the respective customer orders;

to assign the customer envelope and/or the dealers envelope to the matching parts of the customer order, i.e. to the prints and/or the exposed film or its parts.

In any case, it is preferred if the above objects can also be solved either if the prints of one ore several customer orders are exposed on print paper of different quality and/or type.

In accordance with the invention a photographic web cutter device for cutting a web of photographic paper prints related to a plurality of customer orders, includes magazines for the web, a cutter portion and a control portion, comprising that said control portion controls the cutting operation by means of control data so that cut parts of the photographic web can be assigned to a related customer order.

The advantages of the present invention are based on the fact that the control portion of the device according to the invention controls the cutting operation by means of control data so that cut parts of the photographic web can be assigned to a related customer order, i.e. an envelope including the film which is cut from a film roll or film batch in accordance with control information by a further cutter device, the envelope being provided with an identification code, e.g. two bar codes, which are also fixed to the film.

If films are processed in a large dimension photo finishing lab, the incoming negative films are provided with recognition data or match codes relating to the particular photo shop with which the customer has placed his order for the photographic prints. Such recognition data is usually in the form of a bar code or similar, referred to above. This bar code or another bar code which is related to the bar codes of the customer and/or the photo shop, or these recognition data themselves, are fixed to the film when the film is spliced together with the films of other customers and/or photo shops. On the basis of these recognition data, a central control device, a computer server or the like, is able to monitor the prosecution of all processes throughout the photo finishing lab. Usually, there is another image data server in case digital image data are used to expose the photosensitive paper.

Accordingly, if it is necessary to expose the photographs of one customer order on several types of photosensitive paper, it is necessary later to assign the respective film, which is part of a film batch, to one, two, three or more different paper print batches, for instance the royal batch, the glossy batch and/or the matt batch. Usually, one customer order has to be assigned to one type of photosensitive paper.

Therefore, if in the photo laboratory the film batch is again cut down to the particular customer orders, the film of the particular customer orders again have to be assigned to the corresponding paper prints. Accordingly, if the film portions assigned to one customer order are cut, a corresponding match code will be recognised on the film and in accordance with this match data the photographic paper web cutter device according to the present invention receives control data requesting to dispense paper prints from the matching magazine which receives the right paper type, wherein e.g. three magazines are related to the different paper types. Thus, the paper prints can be combined with the assigned film or film portions to complete the customer order.

Accordingly, it is possible to dispense the assigned paper prints from the respective magazine or magazines of a print web cutter device in accordance with the invention in reaction to the corresponding control information, i.e. the match code or the like sent by either a central computer server of the lab or by a film cutter, to cut them away from the paper print batch and to dispense them to be assembled with other elements of the particular customer order, e.g. the developed film, a photo-CD, a floppy-disk, an index print or the like.

Accordingly, to be able to dispense paper prints from several batches of different paper qualities in relation to the assigned film portion to be cut from a roll of spliced or attached films, i.e. a film batch, it is necessary that the cutter device according to the present invention includes a number of magazines for the corresponding number of print batches to be able to roll off the paper prints or the film negatives which are related to the assigned customer order.

The same applies if the customer order comes via internet and the customer wishes that some of the total number of pictures be exposed on different types or qualities of photosensitive print paper. In this case, the central server and/or the computer of the cutter device has to provide control signals to unreel and separate the assigned paper prints from the different paper print batches. Correspondingly, the cutter device according to the present invention again needs several magazines for print batches to be unreeled and cut in an assignment or allotment to the corresponding customer order.

Preferably, only one cutter portion is provided to cut the corresponding images from the photo paper batches stemming from the corresponding magazines. For this purpose, it is necessary that between the magazines and the cutter portion there is arranged a switch, a selector and/or a point arrangement to be able to guide said webs of paper prints, controlled by said control portion in relation to the assigned customer, order to said cutter portion. Accordingly, only one cutter portion is necessary to serve several magazines with photo paper batches. On the other hand, it is also an acceptable arrangement in accordance with the present invention, if a plurality of cutter portions is assigned to said plurality of magazines of the cutter according to the invention. If the number of magazines with rolls off the webs does not correspond to or is not equal to the number of cutter portions, a corresponding number of switch or selector arrangements has to be provided to guide the webs to cutter portions.

It is advantageous to splice together the different film negatives of a huge number of films to expose the film negatives on photosensitive paper of different qualities in accordance with the wishes or instructions of the customer and it may also be necessary to cut negative film portions from several film negative batches in assignment to a particular customer order and in assignment to the paper prints of different types of paper, the prints also being assigned to this particular customer order. This necessity occurs e.g., if the films of a huge number of customer orders have to be cut to separate the films into batches for different print paper types. To reassign the film parts, also the film cutter in accordance with the present invention can be provided with at least one magazine, or preferably with three magazines, for rolls of film negatives or film batches composed of a vast number of customer orders.

Films to be developed arrive in the lab in an envelope which can be identified usually by two bar codes: the first code identifies the dealer or photo shop, while the second identifies the specific order, i.e. the customer, correspondingly, a customer can ask in the photo shop for his specific order by means of a receipt including these e.g. two codes. Moreover, in addition to the usual dealer envelope, it is also possible to use a so-called Eurocombi-envelope.

It may arise that the employee in the photo shop or the dealer places the customer order in an envelope (so-called dealer envelope). This dealer envelope has all the recognition data (e.g. the two bar codes) and the processing information or instructions on it. After the customer order has been completed, all items of this order are again assigned to the original dealer envelope and this envelope is put into a wallet and is delivered to the dealer to be handed over to the customer.

In contrast to the dealer envelope, the Eurocombi envelope allows all items to be placed into this Eurocombi envelope during the submission phase from the photo shop or dealer to the lab and back from the lab to the photo shop or dealer. Accordingly, with the Eurocombi envelope, the over-all process is less diversified and, thus, less expensive.

The customer may select from a considerable variety of different processing possibilities regarding paper types, surfaces and formats. This selection is performed by marking a specific box on the dealer envelope/Eurocombi-envelope.

When the material arrives at the lab, it is sorted to create homogeneous orders depending on the customer request e.g. 10×15 on glossy paper, 10×15 on matt paper, 10×15 on royal paper, 13×18 on matt paper . . . ).

Homogeneous customer orders which will have to be processed the same way, are spliced together to a film batch to form a continuous roll of typically 100-200 orders.

On the splice material or splice paper, a code is printed which is associated to a specific customer.

Then, the film is developed and exposed on the selected paper.

The increase in digital service offers (CD, floppy, index print . . . ) and the possibility of being more flexible on marketing offers implies a fragmentation of batches. Accordingly, this is a reduction in the number of films which have to be processed the same way meaning that the batches are becoming smaller. Smaller batches and thus a larger number of batches increases the handling costs for the photo lab.

Therefore, it is an aim of the present invention to reduce the number of divisions in such a way as to increase the sizes of the batches dimensions/productivity.

The gist of the invention is to reduce the selection only to the paper width and not to the paper type or surface. According to the invention, this is now possible due to the availability of new digital devices, e.g. film scanners, data device managers and digital printers, etc.

According to this invention, at the splicer the films arrive only to be distinguished by the paper width, on which the films have to be exposed. The variation in the paper type or paper surface is no longer important.

Furthermore, the advantages of the present invention are deemed to be the automatic cutting and the automatic assignment of the paper images to a corresponding related customer order.

### BRIEF DESCRIPTION OF THE DRAWINGS

In the following, preferred embodiments in accordance with the present invention are described based on the drawings attached hereto. In the drawings and the related specification, also further features, advantages and achievements in accordance with the present invention are disclosed, wherein:

FIG. 1 shows a schematic view of a cutter in accordance with the invention; and

FIG. 2 shows a schematic view of another cutter device which is in accordance with the invention.

### DETAILED DESCRIPTION OF THE PREFERRED EMBODIMENTS

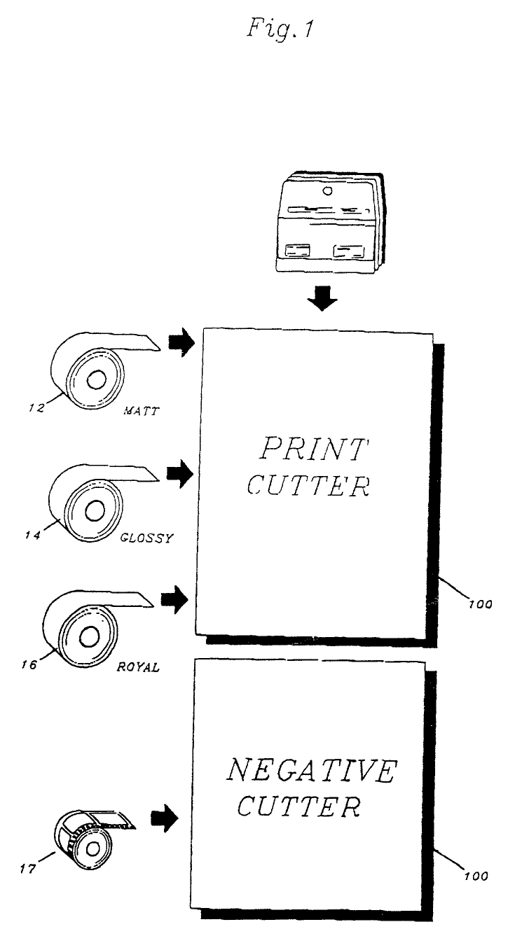

In FIG. 1, a cutter device 10 in accordance with the invention includes several magazines 12, 14, 16 to receive film batches or paper batches which have to be unreeled and cut.

As can be seen, the particular embodiment 10 only includes three magazines, however, it is also possible that it includes only two magazines or additional magazines, not only for further types of print paper, but also magazines to expand the duty cycle of the cutter according to the invention. In other words, regarding each of the magazines 12, 14, 16, there might be an additional magazine which is connected to the transportation paths in the cutter 10 via a points or selector arrangement or the like. In such a construction, an automatic change between two magazines containing print paper of the same type could be accomplished. Accordingly, if one magazine is empty, the cutter device could detect this by means of a sensor and could change over to the second magazine to supply further prints, while the first magazine is loaded with another print paper batch.

The paper portions which are dispensed from the magazines 12, 14, 16 are fed via transportation or conveyer paths 22, 24a, 24b, 24c, which are constructed such that the film negatives and/or the paper images are not at risk of being damaged or scratched.

It can also be necessary to provide an arrangement to withdraw or move back film or print sections enabling print sections of the corresponding batches, which are unreeled or dispensed from the magazine and which do not have to be cut since the corresponding sections which have been unreeled do not belong to an assigned customer order which has to be processed, to be withdrawn into the corresponding magazine. In other words, if the transportation path between the magazines and one cutter portion is shared partly, the web portion in the shared part of the transportation path should be withdrawable.

However, in the present case, cutting arrangements are provided for each of the magazines 12, 14, 16 and accordingly it is not necessary to unreel additional parts of the batches to overcome an access distance between a cutter and the sections of the batch which have to be cut.

Corresponding control sections of the cutter device according to the invention receive control signals to cut the right sections of the web away from the matching batch. Additionally, a matching code and/or a quality code on the paper prints or a matching code on the splices of the film negatives can be scanned to check whether the photographic material to be cut from the corresponding batch matches to the corresponding customer order which has to be processed in that instance.

Overall control can be provided by a central laboratory server or laboratory computer which monitors and controls the process of a huge number of customer orders throughout the complete photo lab.

Of course, if developed photosensitive paper has to be processed by the cutter device 10 according to the present invention, the device can be automatically adaptable with respect to the dimensions of the paper prints. Corresponding sensors and motors for the necessary movements of guides, stoppers or bumpers or the like for transporting the paper prints could be provided by an ordinary person skilled in the art, e.g. an engineer with a degree in mechanics and experience in the photo finishing field.

The device 10 according to the invention may also comprise a gripper device, which serves to grip the cut paper prints and to put them in or on a pallet with the dealer envelope or the Eurocombi envelope, or into said envelopes themselves. The corresponding pallet or envelope may come from the film cutter which has already cut the matching film or film sections from the film batch, so that the matching film or film sections are already placed on the pallet or in the envelope. It is also possible to assign the matching film or film sections to the corresponding pallet or paper prints after the paper prints have been assigned.

In FIG. 1, the film cutter 100 is placed behind the device according to the invention, Of course, it is also possible to incorporate the film cutter and it magazine 17 into the cutter device 10 according to the invention.

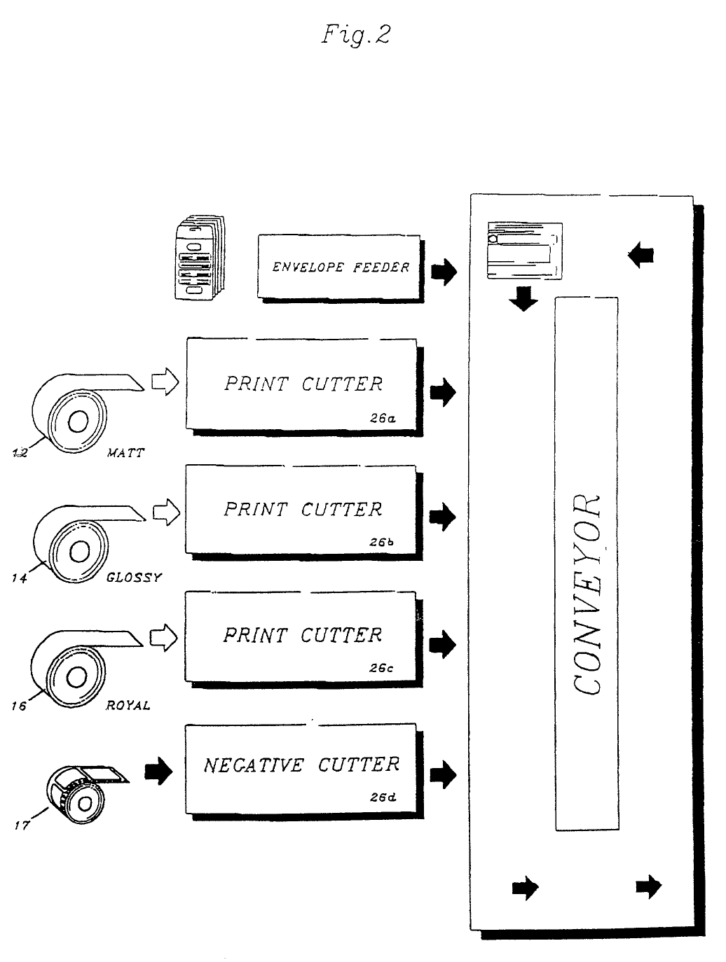

In FIG. 2, a cutter device 10′ according to the invention is depicted, which has different magazines 12, 14, 16, each being provided with its own cutter portion 26a, 26b, 26c.

1. Photographic web cutter device for cutting a web of photographic paper prints related to a plurality of customer orders, including magazines for the web, a cutter portion and a control portion, comprising that said control portion controls the cutting operation by means of control data so that cut parts of the photographic web can be assigned to a related customer order.

1. Photographic web cutter device according to claim 1, comprising that said cutter device includes a number of magazines with rolls of said webs, e.g., print batches.

1. Photographic web cutter device according to claim 2, comprising that, if said paper webs or print batches consist of photographic paper prints of several types of paper belonging to a plurality of customer orders, the rolls of said webs are unreeled such that photographic paper prints assigned to a related customer order are collected after a particular number of cutting operations necessary to separate the photographic paper prints assigned to said particular customer order.

1. Photographic web cutter device according to claim 3, comprising that behind said plurality of magazines there is located a switch, a selector and/or a points arrangement to guide said webs of said batches controlled by said control portion to said cutter portion in response to control data related to a related customer order.

1. Photographic web cutter device according to claim 3, comprising that behind said plurality of magazines there is located a plurality of cutter portions to cut said webs in accordance with control data corresponding to respective customer orders, and if the number of magazines with rolls of webs does not correspond to the number of cutter portions, a number of switches or selectors or similar arrangements is provided to guide the webs of said batches to the cutter portions.

1. Photographic web cutter device according to claim 2, comprising at least three magazines for rolls (batches) of different types of photographic print papers are provided in particular for matt paper prints, glossy paper prints and royal paper prints.

7. Photographic web cutter device according to claim 3, comprising at least three magazines for rolls (batches) of different types of photographic print papers are provided in particular for matt paper prints, glossy paper prints and royal paper prints.

8. Photographic web cutter device according to claim 4, comprising at least three magazines for rolls (batches) of different types of photographic print papers are provided in particular for matt paper prints, glossy paper prints and royal paper prints.

9. Photographic web cutter device according to claim 5, comprising at least three magazines for rolls (batches) of different types of photographic print papers are provided in particular for matt paper prints, glossy paper prints and royal paper prints.

10. Photographic web cutter device according to claim 1, comprising that a further cutter device for a roll of film negatives is located preferably in-line with the web cutter device, said further cutter device having at least one magazine for a roll of film negatives (film batch), wherein said further cutter device is controlled, such that film parts belonging to one customer order are cut in relation to paper prints assigned to said customer order by said cutter device.
